(19) United States
(12) Patent Application Publication
(10) Pub. No.: US 2024/0150620 A1
(43) Pub. Date: May 9, 2024

(54) MULTILAYER COMPOSITE WITH DUAL LAYER PRESSURE-SENSITIVE ADHESIVE

(71) Applicant: BASF SE, Ludwigshafen am Rhein (DE)

(72) Inventor: Singa D. TOBING, Southfield, MI (US)

(21) Appl. No.: 18/281,414

(22) PCT Filed: Mar. 11, 2022
(86) PCT No.: PCT/US2022/019975

§ 371 Date: Sep. 11, 2023

Related U.S. Application Data
(60) Provisional application No. 63/160,663, filed on Mar. 12, 2021.
(60) Provisional application No. 63/256,227, filed on Oct. 15, 2021.

(51) Int. Cl. C09J 7/35; C09J 7/22; C09J 7/38; C09J 7/40; C09J 133/08

(52) U.S. Cl. CPC C09J 7/35; C09J 7/22; C09J 7/38; C09J 7/40; C09J 133/08; C09J 2203/346; C09J 2301/208; C09J 2301/302; C09J 2301/304; C09J 2301/312; C09J 2301/416; C09J 2301/50

(57) ABSTRACT

A multilayer composite containing a polymeric membrane, a hot-melt adhesive layer A, a hot-melt adhesive layer B; and a release liner, wherein the hot-melt adhesive layer A comprises a non-ultraviolet (UV) curable pressure-sensitive adhesive; wherein the hot-melt adhesive layer B comprises a ultraviolet (UV) curable pressure-sensitive adhesive that is at least partially cured; wherein the hot-melt adhesive layer A has a thickness of from 25 to 250 μm, and wherein the hot-melt adhesive layer B has a thickness of from 50 to 250 μm. The invention further relates to a process to make the composite and to use the composite as a roofing material.

### FIELD OF THE INVENTION

This invention pertains to a multilayer composite comprising a polymeric membrane, a first and a second adhesive layer, a second adhesive layer, and a release member.

### BACKGROUND OF THE INVENTION

Multilayer composites, also referred to as multilayer membrane, peel-and-stick membranes or panels, are used in the construction industry to cover flat or low-sloped roofs. These membranes provide protection to the roof from the environment, particularly in the form of a waterproof barrier. As is known in the art, commercially available membranes include thermoset membranes such as those including cured EPDM (i.e., ethylene-propylene-diene terpolymer rubber) or thermoplastics such as TPO (i.e., thermoplastic olefins), PVC (i.e., polyvinylchloride) and modified bitumen.

These membranes are typically delivered to a construction site in a bundled roll, transferred to the roof, and then unrolled and positioned. The sheets are then affixed to the building structure by employing varying techniques such as mechanical fastening, ballasting, and/or adhesively adhering the membrane to the roof. The roof substrate to which the membrane is secured may be one of a variety of materials depending on the installation site and structural concerns. For example, the surface may be a concrete, metal, gypsum, plywood, or wood deck, it may include insulation or recover board, and/or it may include an existing membrane.

In addition to securing the membrane to the roof-which mode of attachment primarily seeks to prevent wind uplift—the individual membrane panels, together with flashing and other accessories, are positioned and adjoined to achieve a waterproof barrier on the roof Typically, the edges of adjoining panels are overlapped, and these overlapping portions are adjoined to one another through a number of methods depending upon the membrane materials and exterior conditions. One approach involves providing adhesives or adhesive tapes between the overlapping portions, thereby creating a water resistant seal. Alternative, if the membranes are thermoplastics, they may be heat sealed.

With respect to the former mode of attachment, which involves securing the membrane to the roof, the use of adhesives allows for the formation of a fully-adhered roofing system. In other words, a majority, if not all, of the membrane panel is secured to the roof substrate, as opposed to mechanical attachment methods that can only achieve direct attachment in those locations where a mechanical fastener actually affixes the membrane.

When adhesively securing a membrane to a roof, such as in the formation of a fully-adhered system, there are a few common methods employed. The first is known as contact bonding whereby technicians coat both the membrane and the substrate with an adhesive, and then mate the membrane to the substrate while the adhesive is only partially set. Because the volatile components (e.g. solvent) of the adhesives are flashed off prior to mating, good early (green) bond strength is developed.

Another mode of attachment is through the use of a pre-applied adhesive to the bottom surface of the membrane. In other words, prior to delivery of the membrane to the job site, an adhesive is applied to the bottom surface of the membrane. In order to allow the membrane to be rolled and shipped, a release film or member is applied to the surface of the adhesive. During installation of the membrane, the release member is removed, thereby exposing the pressure-sensitive adhesive, and the membrane can then be secured to the roofing surface without the need for the application of additional adhesives.

As is known in the art, the pre-applied adhesive can be applied to the surface of the membrane in the form of a hot-melt adhesive. For example, U.S. Publication No. 2004/0191508, which teaches peel and stick thermoplastic membranes, employs pressure-sensitive adhesive compositions comprising styrene-ethylene-butylene-styrene (SEBS), tackifying endblock resins such as cumarone-indene resin and tackifying midblock resins such as terpene resins. This publication also suggests other hot-melt adhesives such as butyl-based adhesives, EPDM-based adhesives, acrylic adhesives, styrene-butadiene adhesives, polyisobutylene adhesives, and ethylene vinyl acetate adhesives.

Further, single layer UV curable acrylic hot melt adhesive coating on EPDM membrane is disclosed, for example, in U.S. Pat. Nos. 10,132,082, 10,519,663, 10,370,854 and U.S. Publication No. 2019-0316359.

These prior applications, however, have inherent limitations. For example, there are temperature windows that limit the minimum temperature at which peel-and-stick membranes can be installed on a roof surface. Additionally, there are maximum temperature limits on the roof surface that the adhesive can withstand while maintaining wind-uplift integrity. With respect to the latter, where the surface temperature on the roof nears the glass transition temperature of the adhesive, the adhesive strength offered by the pressure-sensitive adhesive is not maintained. Further, the large difference in thermal expansion-contraction coefficient and elasticity between the adhesive layer and the membrane can create tunneling or puckering when the laminate is installed at higher temperature on a roofing deck and naturally cooled down to ambient temperatures at night time. Similarly, tunneling or puckering may arise upon rising temperature, when membrane and roof deck are adhered to one another at below freezing temperatures.

While is it is also known to UV cure the pressure sensitive adhesives, inherent limitations as to how much radiation energy maybe supplied to a given adhesive layer exists. The greater the thickness of the layer, the greater the energy need. However, it is known that extensive radiation leads to non-uniformities in the layer.

As a result, peel-and-stick membranes have not gained wide acceptance in the industry. Moreover, the use of peel-and-stick membranes has been limited to use in conjunction with white membranes (e.g., white thermoplastic membranes) because the surface temperature of these membranes remains cooler when exposed to solar energy.

Accordingly, there is a need for peel-and-stick membrane or multilayer composite which are not sensitive to the above identified limitation, are suitable for any time installation without exhibiting channeling and tunneling, and are UV curable without leading to non-uniformities within the adhesive layer.

### BRIEF SUMMARY OF THE INVENTION

It was an object of the invention to develop a multilayer composite comprising a polymeric membrane, a first and a second adhesive layer, wherein one of the adhesive layers may comprise a UV-curable adhesive layer that is not UV-cured prior to being combined with the second adhesive layer or an latex emulsion adhesive, and a release member.

The following are embodiments of the invention:

Embodiment 1 is a multilayer composite comprising:
a polymeric membrane;
a adhesive layer A;
a hot-melt adhesive layer B; and
a release liner,
   wherein the adhesive layer A comprises an ultraviolet (UV) curable pressure-sensitive adhesive or a water-borne latex adhesive;
   wherein the hot-melt adhesive layer B comprises a ultraviolet (UV) curable pressure-sensitive adhesive that is at least partially cured;
   wherein the adhesive layer A has a thickness of from 25 to 250 μm, and wherein the hot-melt adhesive layer B has a thickness of from 50 to 250 μm.

Embodiment 2—The multilayer composite of embodiment 1, wherein the adhesive layer A does not undergo UV cure prior to combination with layer B.

Embodiment 3—The multilayer composite of embodiments 1 or 2, wherein the adhesive layer A is in contact with substantially all of one planar surface of the polymeric membrane.

Embodiment 4—The multilayer composite of any one of the embodiments 1, 2 or 3, wherein the hot-melt adhesive layer B is in contact with substantially all of one planar surface of the polymeric membrane.

Embodiment 5—The multilayer composite of any one of the embodiments 1, 2, 3, or 4, wherein the adhesive layer A comprises a UV-cured poly(acrylate) resin.

Embodiment 6—The multilayer composite of any one of the embodiments 1, 2, 3, 4 or 5 wherein the water-borne latex adhesive comprises at least one styrene/acrylic latex, acrylic latex, Styrene butadiene latex or Nitrile Butadiene Latex.

Embodiment 7—The multilayer composite of any one of the embodiments 1, 2, 3, 4, 5 or 6 wherein the water-borne latex adhesive is derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

Embodiment 8—The multilayer composite of any one of the embodiments 1, 2, 3, 4, 5, 6 or 7, wherein the hot-melt adhesive layer B is selected from the group consisting of UV curable acrylic PSA and UV curable styrenic block copolymer PSA.

Embodiment 9—The multilayer composite of any one of the embodiments 1, 2, 3, 4, 5, 6, 7 or 8, wherein the polymeric membrane is selected from the group consisting of thermoplastic membrane, ethylene-propylene-diene terpolymer rubber (EPDM), TPO, PVC, modified bitumen, rubber membrane, asphaltic membranes, and fibrous membranes.

Embodiment 10—The multilayer composite of any one of the embodiments 1, 2, 3, 4, 5, 6, 7, 8, or 9 wherein the multilayer composite has a peel strength, when adhered to a stainless steel panel and tested according to PSTC 101, of at least 6 psi.

Embodiment 11—The multilayer composite of any one of the embodiments 1, 2, 3, 4, 5, 6, 7, 8, 9 or 10, where the multilayer composite has a dead load shear, when adhered to a stainless steel panel and tested according to PSTC 107, of at least 0.5 hour.

Embodiment 12—The multilayer composite of any one of the embodiments 1, 2, 3, 4, 5, 6, 7, 8, 9, 10, or 11, wherein the adhesive layer A has a thickness of from 25 to 100 μm, and wherein the hot-melt adhesive layer B has a thickness of from 50 to 100 μm.

Embodiment 13—The multilayer composite of any one of the embodiments 1, 2, 3, 4, 5, 6, 7, 8, 9, 10, 11 or 12, wherein the adhesive layer A further comprises one or more additive.

Embodiment 14—The multilayer composite of any one of the embodiments 1, 2, 3, 4, 5, 6, 7, 8, 9, 10, 11, 12 or 13, wherein the multilayer composite is a roofing membrane.

Embodiment 15—A roofing membrane comprising the multilayer of any one of the embodiments 1-14.

Embodiment 16—A process for forming a multilayer composite, the process comprising:
(a) heating a melt-extrudable, UV-curable pressure-sensitive layer A,
(b) heating a melt-extrudable, UV-curable pressure-sensitive adhesive B,
(c) extruding the layer A and the adhesive B to a planar surface of a polymeric membrane such that adhesive is in contact with substantially all of one planar surface of the polymeric membrane, forming an adhesive coating layer comprising an adhesive layer A and a hot-melt adhesive layer B;
wherein the adhesive layer A has a thickness of from 25 to 250 μm, and
wherein the hot-melt adhesive layer B has a thickness of from 50 to 250 μm,
(d) subjecting the adhesive coating layer to UV radiation;
(e) optionally, cooling the adhesive coating layer;
(f) applying a release liner to the adhesive coating layer to form a multilayer composite; and
(g) winding the composite.

Embodiment 17—The process of embodiment 16, wherein the melt-extrudable, UV-curable pressure-sensitive layer A further comprises a water-borne latex adhesive.

Embodiment 18—The process of embodiment 16, or 17, wherein in step (c) the adhesive A and the adhesive B are coextruded simultaneously.

Embodiment 19—The process of embodiment 16, or 17, wherein in step (c) the adhesive layer A and the adhesive B are extruded sequentially.

Embodiment 20—The process of any one of the embodiments 16, 17, 18 or 19, wherein the adhesive layer A comprises a UV-curable poly(acrylate) resin, and a water-borne latex adhesive.

Embodiment 21—The process of any one of the embodiments 16, 17, 18, 19 or 20, wherein the hot-melt adhesive layer B comprises a UV-cured poly(acrylate) resin.

Embodiment 22—The process of any one of the embodiments 16, 17, 18, 19, 20 or 21, wherein the hot-melt adhesive layer B is selected from the group consisting of UV curable acrylic PSA and UV curable styrenic block copolymer PSA.

Embodiment 23—The process of any one of the embodiments 16, 17, 18, 19, 20, 21 or 22, wherein the polymeric membrane is selected from the group consisting of thermoplastic membrane, ethylene-propylene-diene terpolymer rubber (EPDM), TPO, PVC, modified bitumen, rubber membrane, asphaltic membranes, and fibrous membranes.

Embodiment 24—The process of any one of the embodiments 16, 17, 18, 19, 20, 21, 22 or 23, wherein the coextruding simultaneously the adhesive A and the adhesive B are coextruded simultaneously in a dual slot die configuration onto a moving web of thermoplastic membrane, ethylene-propylene-diene terpolymer rubber (EPDM), TPO, PVC, modified bitumen, rubber membrane, asphaltic membranes, and fibrous membranes

Embodiment 25—The process of any one of the embodiments 16, 17, 18, 19, 20, 21. 22, 23 or 24, wherein the adhesive A and/or the adhesive B comprises an additive selected from the group consisting of a tackifier, a plasticizer, one or more photoinitiator.

Embodiment 26—The process of any one of the embodiments 16, 17, 18, 19, 20, 21. 22, 23, 24 or 25, wherein the adhesive A/B is heated to a temperature of from about 120 to about 160° C.

Embodiment 27—The process of any one of the embodiments 16, 17, 18, 19, 20, 21. 22, 23, 24, 25 or 26, wherein subjecting the coating to UV radiation comprises subjecting the adhesive coating layer to a UV dosage of from about 40 to about 80 millijoules/cm².

Embodiment 28—The process of any one of the embodiments 16, 17, 18, 19, 20, 21. 22, 23, 24, 25, 26 or 27, wherein the multilayer composite has a width of from about 1 to about 20 meters.

Embodiment 29—A method for roofing a structure comprising
(a) providing the multilayer composite of any one of embodiments 15,
(b) removing the release liner from the multilayer composite forming linerless multilayer composite, and
(c) adhering/laminating/installing the linerless multilayer composite onto a roof substructure forming a roof laminate.

Embodiment 30—A multilayer composite comprising:
a substrate;
an adhesive layer A;
a hot-melt adhesive layer B; and
a release liner,
   wherein the adhesive layer A comprises an ultraviolet (UV) curable pressure-sensitive adhesive and a water-borne latex adhesive;
   wherein the hot-melt adhesive layer B comprises a ultraviolet (UV) curable pressure-sensitive adhesive that is at least partially cured;
   wherein the adhesive layer A has a thickness of from 25 to 250 μm, and wherein the hot-melt adhesive layer B has a thickness of from 50 to 250 μm.

The foregoing embodiments are just that and should not be read to limit or otherwise narrow the scope of any of the inventive concepts otherwise provided by the instant disclosure. While multiple embodiments are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

FIG. 1a is a cross-section view of a membrane composite according to embodiments of the invention.

FIG. 1b is a cross-section view of a membrane composite according to embodiments of the invention.

FIG. 2 is a cross section of a dual slot die coextruding A and B onto polymeric membrane.

### DETAILED DESCRIPTION OF THE INVENTION

The following examples further illustrate the invention but, of course, should not be construed as in any way limiting its scope. Provided herein are multilayer composites, particularly useful as roofing membranes. The multilayer composites of the instant invention comprise a polymeric membrane, a first adhesive layer A comprising an ultraviolet (UV) curable pressure-sensitive adhesive that does not undergo UV cure prior to being combined with the second hot-melt adhesive layer, or a water-borne latex adhesive, a second adhesive layer B comprises a ultraviolet (UV) curable pressure-sensitive adhesive that is at least partially cured, and a release liner, each component described in detail below.

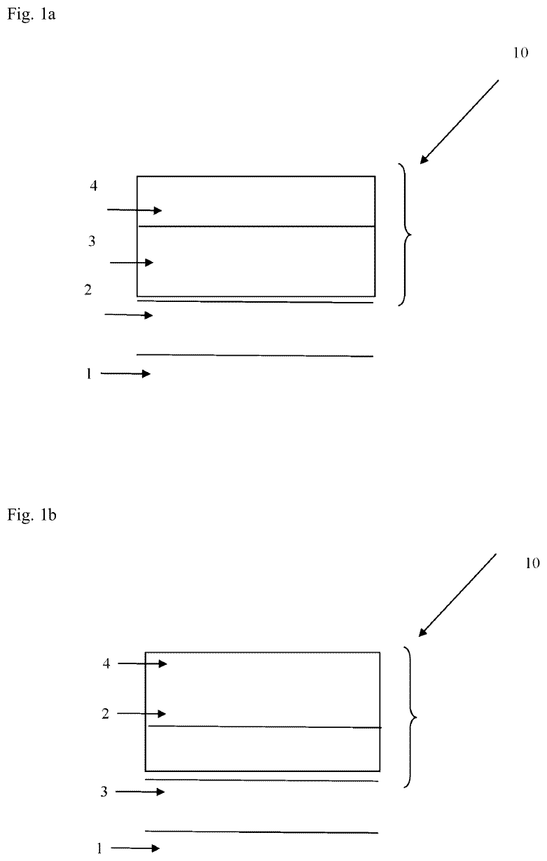

FIG. 1a shows multilayer composite 10, which may be referred to as a membrane 10. Multilayer composite 10 includes polymeric membrane 1, a pressure-sensitive adhesive layer UV curable adhesive layer A 2, a pressure-sensitive UV curable adhesive layer B 3, and a release liner 4 removably attached to layer 3. In FIG. 1b, the order of the adhesive layers A and B is reversed.

Polymeric Membrane/Substrate

According to various embodiments described herein, the polymeric membrane may be a thermoplastic membrane, an ethylene-propylene-diene terpolymer rubber (EPDM) based membrane, a TPO based membrane, a PVC based membrane, a member based on other polymerics [details], a rubber membrane, an asphaltic membranes, or a fibrous membranes. These membranes may be flexible, rollable or in sheet form.

In one or more embodiments, the membrane includes EPDM membranes including those that meet the specifications of the ASTM D-4637. In other embodiments, the membrane includes thermoplastic membranes including those that meet the specifications of ASTM D-6878-03.

The polymer membrane is not particularly limited in its thickness. However, for commercial applications, and particularly for those in the roofing industry, the polymeric membrane has a thickness of from about 500 μm to about 3 mm, from about 1,000 μm to about 2.5 mm, or from about 1,500 μm to about 2 mm.

In one or more embodiments, instead of a polymeric membrane a substrate is contemplated. Generally, the substrate is more rigid compared to a polymeric membrane. For examples, substrate may be gypsum, oriented strand board (OSB), metal and plywood. The substrate is not particularly limited in its thickness.

Adhesive A

According to various embodiments described herein, the adhesive that may be used for forming the pressure-sensitive adhesive layer A may comprise an acrylic copolymer. In another embodiment adhesive layer A may comprise a water-borne latex adhesive.

As used herein, the term “theoretical glass transition temperature” or “theoretical Tg” refers to the estimated Tg of a polymer or copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below

1/T_{g}=wa/T_{ga}+wb/T_{gb}+ . . . +wi/T_{gi}

where wa is the weight fraction of monomer a in the copolymer, T_{ga} is the glass transition temperature of a homopolymer of monomer a, wb is the weight fraction of monomer b in the copolymer, T_{gb} is the glass transition temperature of a homopolymer of monomer b, wi is the weight fraction of monomer i in the copolymer, T_{g}i is the glass transition temperature of a homopolymer of monomer i, and T_{g} is the theoretical glass transition temperature of the copolymer derived from monomers a, b, . . . , and i.

“Copolymer” refers to polymers containing two or more monomers.

“Homopolymer” refers to a polymer formed from one species of monomer.

As used herein, the term “(meth)acrylate monomer” includes acrylate, methacrylate, diacrylate, and dimethacrylate monomers.

According to various embodiments described herein, the acrylic copolymer comprising layer A may be based on a polymerization of a monomer A, a monomer B, and a monomer C.

According to various embodiments described herein, monomer A may include methyl, ethyl, propyl, isoamyl, isooctyl, n-butyl, isobutyl, tert-butyl, cyclohexyl, 2-ethylhexyl, decyl, lauryl or stearyl acrylate and/or methacrylate, and any mixture thereof.

According to various embodiments described herein, monomer A may have a Tg of less than −20° C. For example, the Tg may be −30° C. or less, −40° C. or less, −45° C. or less, −50° C. or less, −55° C. or less, or −60° C. or less. The glass transition temperature can be determined by differential scanning calorimetry (DSC) by measuring the midpoint temperature using ASTM D 3418-12e1.

According to various embodiments described herein, monomer B may include acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid or vinylphosphonic acid, and mixtures thereof.

According to various embodiments described herein, monomer C may include methyl acrylate, methyl methacrylate, ethyl methacrylate, n-butyl methacrylate, tert-butyl methacrylate, tert-butyl acrylate, isobutyl methacrylate, vinyl acetate, hydroxyethyl acrylate, hydroxyethyl methacrylate, cyclohexyl acrylate, cyclohexyl methacrylate, 2-ethoxyethyl methacrylate, 2-phenoxyethyl methacrylate, benzyl acrylate, benzyl methacrylate, hydroxypropyl methacrylate, styrene, 4-acetostyrene, acrylamide, acrylonitrile, 4-bromostyrene, n-tert-butylacrylamide, 4-tert-butylstyrene, 2,4-dimethylstyrene, 2,5-dimethylstyrene, 3,5-dimethylstyrene, isobornyl acrylate, isobornyl methacrylate, 4-methoxystyrene, methylstyrene, alpha methylstyrene, 4-methylstyrene, 3-methylstyrene, 2,4,6-trimethylstyrene, vinyl pyrrolidone, ureido methacrylate and combinations thereof.

According to some embodiments, the acrylic copolymer may contain monomer A in an amount of from 50% by weight to 99.99% by weight based on the weight of the monomers A, B and C in the copolymer.

According to some embodiments, the acrylic copolymer may contain monomer B in an amount of from 0.1% by weight to 25% by weight based on the weight of the monomers A, B and C in the copolymer.

According to some embodiments, the acrylic copolymer may contain monomer C in in an amount of from 0.1% by weight to 25% by weight based on the weight of the monomers A, B and C in the copolymer.

The acrylic copolymer may include some percentage of carboxylic acid functionality, for example acrylic acid. The acrylic acid functionality may be present in an amount of about 5 wt. % or greater, about 6 wt. % or greater, about 7 wt. % or greater, about 8 wt. % or less, about 9 wt. % or less, about 10 wt. % or less, or any value encompassed by these endpoints, based on the total weight of the polymer.

The acrylic copolymer can be prepared by known processes.

The weight average molecular weight (M_{w}) of the acrylic copolymer can be, for example, 150,000 Da or more (e.g., 160,000 Da or more, 170,000 Da or more, 180,000 Da or more, 190,000 Da or more, 200,000 Da or more, 200,000 Da or more, 210,000 Da or more, 220,000 Da or more, 230,000 Da or more, 240,000 Da or more). In some examples, the weight average molecular weight (M_{w}) of the acrylic copolymer can be 250,000 Da or less (e.g., 240,000 Da or less, 230,000 Da or less, 220,000 Da or less, 210,000 Da or less, 200,000 Da or less, 190,000 Da or less, 180,000 Da or less, 170,000 Da or less, 160,000). The weight average molecular weight (M_{w}) of the acrylic copolymer can range from any of the minimum values described above to any of the maximum values described above. For example, the weight average molecular weight (Mw) of the acrylic copolymer can be from 150,000 Da to 250,000 Da (e.g., from 170,000 Da to 220,000 Da, or from 190,000 Da to 200,000 Da). The weight average molecular weight (M_{w}) of the acrylic copolymer can be determined by GPC (gel permeation chromatography).

The number average molecular weight (Mₙ) of the acrylic copolymer can be, for example, 20,000 or more (e.g., 30,000 or more, or 40,000 or more). In some examples, the number average molecular weight (Mₙ) of the acrylic copolymer can be 50,000 or less (e.g., 40,000 or less, or 30,000 or less). The number average molecular weight (Mₙ) of the acrylic copolymer can range from any of the minimum values described above to any of the maximum values described above. For example, the number average molecular weight (Mₙ) of the acrylic copolymer can be from 20,000 to 50,000 (e.g., from 30,000 to 50,000, or from 40,000 to 50,000). The number average molecular weight (Mₙ) of the acrylic copolymer can be determined by GPC (gel permeation chromatography).

The dispersity DM calculated as M_{w}/Mₙ where M_{w} is the mass-average molar mass (or molecular weight) and Mₙ is the number-average molar mass (or molecular weight) of the acrylic copolymer may be more than 5 (e.g., more than 6, or more than 7, or more than 8, or more than 9 or more than 10). The dispersity of the acrylic copolymer may be less than 11 (e.g., less than 10, less than 9, less than 8, less than 7, or less than 6). The dispersity of the acrylic copolymer can range from any of the minimum values described above to any of the maximum values described above. For example, the dispersity of the acrylic copolymer can be from 5 to 11, or from 7 to 9.

If the copolymers are to be used as contact adhesives, the acrylates and/or methacrylates used as principal monomers are preferably those whose homopolymers have glass transition temperatures below 0° C., in particular below −10° C., in particular n- and isobutyl acrylate and methacrylate, isoamyl and isooctyl acrylate and methacrylate and 2-ethylhexyl acrylate and methacrylate, as well as decyl acrylate and lauryl acrylate and methacrylate. The amount of these principal monomers is then preferably more than 60% of the total monomers.

The copolymers generally contain from, 0.01 to 10% by weight of copolymerized monomers of the general formula I, although amounts of from 0.01 to 5% by weight, based on the copolymers, are frequently sufficient. Copolymers which contain from 0.5 to 25, in particular from 5 to 15, % by weight of tetrahydrofurfur-2-yl (meth)acrylate in addition to other acrylates and monomers of the general formula I as copolymerized units often have a very low molecular weight and a low viscosity.

Although the pressure sensitive adhesive comprising layer A is capable of undergoing UV cure, layer A does not undergo UV curing prior to being combined with layer B, which is described further below.

Water-borne Latex Adhesive

Adhesive A may comprise a water-borne latex adhesive. A suitable water-borne latex adhesive displays high initial tack, good performance at low temperatures, high water resistance, and high durability. The water-borne latex adhesive may be substantially free of organic solvents. The water-borne latex adhesive may be comprised of at least one styrene/acrylic latex, acrylic latex, styrene butadiene latex or nitrile butadiene latex. The layer must be able to withstand plasticizer migration from the EPDM membrane.

The at least one styrene/acrylic latex or acrylic latex may include a plurality of polymer particles. The particles can have a particle size distribution range, as determined by static light scattering, dynamic light scattering, capillary hydrodynamic fractionation or microscope image analysis. For example, the methods described in ASTM E3247-20 and reported as volume average particle size, no greater than 5,000 nm, no greater than 4,000 nm, no greater than 3,000 nm, no greater than 2,000 nm, no greater than 1,000 nm, no greater than 750 nm, no greater than 500 nm, no greater than 400 nm, no greater than 300 nm, no greater than 200 nm, or no greater than 100 nm. In some embodiments, the particles have a particle size from 10-5,000 nm, from 10-4,000 nm, from 10-3,000 nm, from 10-2,000 nm, from 10-1,000 nm, from 10-750 nm, from 10-500 nm, from 10-400 nm, from 10-300 nm, from 10-200 nm, from 10-100 nm, from 10-50 nm, from 50-5,000 nm, from 50-4,000 nm, from 50-3,000 nm, from 50-2,000 nm, from 50-1,000 nm, from 50-750 nm, from 50-500 nm, from 50-400 nm, from 50-300 nm, from 50-200 nm, from 50-100 nm, from 100-1,000 nm, from 100-750 nm, from 100-500 nm, from 100-400 nm, from 100-300 nm, or from 100-200 nm.

In some embodiments, the particles have a particle size from 20-400 nm. In some embodiments, the particles have a particle size from 30-300 nm.

The particles can be prepared by polymerizing a monomer mixture emulsified in water, for instance by emulsion polymerization, optionally in the presence of a polymeric seed. In some embodiments, the particles can include at least two different copolymers (a multi-stage copolymer), e.g., a styrene/acrylic copolymer, an acrylic polymer, a second copolymer, a third copolymer, etc. In some embodiments, the styrene/acrylic copolymer polymer or acrylic polymer, second copolymer, etc. can be prepared in separate reaction vessels, and then combined. In preferred embodiments, the second copolymer, third copolymer, etc. is prepared by polymerizing a monomer mixture in the presence of the styrene/acrylic copolymer or the acrylic polymer.

The styrene/acrylic copolymers and acrylic polymers may be derived from at least one monomer selected from the group consisting of styrene, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and -methacrylamide, maleic acid monoamide and diamide, itaconic acid monoamide and diamide, fumaric acid monoamide and diamide, vinylsulfonic acid, and vinylphosphonic acid.

The styrene/acrylic latex or acrylic latex may further include a crosslinkable monomers such as diacetone acrylamide and its derivatives, and 2-(methacryloyloxy)ethyl acetoacetate and its derivatives.

Preferably, the styrene/acrylic latex or acrylic may be derived from at least one monomer selected from styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid, diacetone acrylamide and 2-(methacryloyloxy)ethyl acetoacetate.

The styrene/acrylic latex or acrylic latex may further include a crosslinking agent that can react with the crosslinkable monomers described above. The crosslinking agent may include adipic dihydrazide (ADDH); multifunctional amines; and metal ions, such as copper, magnesium, zinc, calcium, iron, chromium, titanium, aluminum, and zirconium, for example. Preferrably, the metal ions are zinc, aluminum or zirconium.

In some embodiments, the glass transition temperature (Tg) of the styrene/acrylic latex or acrylic latex can range from −60° C. to 30° C. For example, the Tg may be −40° C. or greater, −35° C. or greater, −30° C. or greater, −25° C. or greater, −20° C. or greater, −15° C. or greater, −10° C. or less, −5° C. or less, 0° C. or less, 5° C. or less, or 10° C. or less. The glass transition temperature can be determined by differential scanning calorimetry (DSC) by measuring the midpoint temperature using ASTM D 3418-12e1.

The Tg of the styrene/acrylic latex or acrylic latex can be between any of the values described above. For example, the Tg can range from −60° C. to 30° C. (e.g., from 0° C. to 5° C., from 0° C. to 5° C., from −10° C. to −30° C., or from −20° C. to −40° C., for example).

The styrene/acrylic latex or acrylic latex may include a soft phase. The glass transition temperature (Tg) of the soft phase may be 20° C. or less, 15° C. or less, 10° C. or less, 5° C. or less, 0° C. or less, −5° C. or less, or −10° C. or less.

The Tg of the soft phase of the polymer may be calculated by the Flory-Fox equation, shown below, wherein Tg is the glass transition temperature, Tg,∞ is the maximum glass transition temperature that can be achieved at a theoretical infinite molecular weight, Mₙ is the number average molecular weight of the polymer, and K is an empirical parameter related to the free volume present in the polymer sample.

T_{g}=T_{g,∞}−K/Mₙ

The acrylate component of the styrene/acrylic latex or acrylic latex can be derived from one or more soft ethylenically-unsaturated monomers. As used herein, the term “soft ethylenically-unsaturated monomer” refers to an ethylenically-unsaturated monomer that, when homopolymerized, forms a polymer having a glass transition temperature, as measured using differential scanning calorimetry (DSC), of 20° C. or less. Soft ethylenically-unsaturated monomers are known in the art, and include, for example, methyl acrylate (Tg=10° C.), ethyl acrylate (Tg=−24° C.), n-butyl acrylate, (Tg=−54° C.), sec-butyl acrylate (Tg=−26° C.), n-hexyl acrylate (Tg=−45° C.), n-hexyl methacrylate (Tg=−5° C.), 2-ethylhexyl acrylate (Tg=−85° C.), 2-ethylhexyl methacrylate (Tg=−10° C.), octyl methacrylate (Tg=−20° C.), n-decyl methacrylate (Tg=−30° C.), isodecyl acrylate (Tg=−55° C.), dodecyl acrylate (Tg=−3° C.), dodecyl methacrylate (Tg=−65° C.), 2-ethoxyethyl acrylate (Tg=−50° C.), 2-methoxy acrylate (Tg=−50° C.), and 2-(2-ethoxyethoxy)ethyl acrylate (Tg=−70° C.).

In some embodiments, soft phase can include a soft ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less). In certain embodiments, the soft ethylenically-unsaturated monomer can be a (meth)acrylate monomer. In certain embodiments, the acrylate component of the styrene/acrylic latex or acrylic latex can be derived from a soft ethylenically-unsaturated monomer selected from the group consisting of n-butyl acrylate, ethyl acrylate, sec-butyl acrylate, 2-ethylhexyl (meth)acrylate, and combinations thereof.

In some embodiments, soft phase can include a hard ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less). Hard ethylenically-unsaturated monomers are known in the art, and include, for example, methyl methacrylate (Tg=105° C.), ethyl methacrylate (Tg=65° C.), n-butyl methacrylate (Tg=20° C.), tert-butyl methacrylate (Tg=118° C.), tert-butyl acrylate (Tg=45° C.), isobutyl methacrylate (Tg=53° C.), vinyl acetate (Tg=30° C.), hydroxyethyl acrylate (Tg=15° C.), hydroxyethyl methacrylate (Tg=57° C.), cyclohexyl acrylate (Tg=19° C.), cyclohexyl methacrylate (Tg=92° C.), 2-ethoxyethyl methacrylate (Tg=16° C.), 2-phenoxyethyl methacrylate (Tg=54° C.), benzyl acrylate (Tg=6° C.), benzyl methacrylate (Tg=54° C.), hydroxypropyl methacrylate (Tg=76° C.), styrene (Tg=100° C.), 4-acetostyrene (Tg=116° C.), acrylamide (Tg=165° C.), acrylonitrile (Tg=125° C.), 4-bromostyrene (Tg=118° C.), n-tert-butylacrylamide (Tg=128° C.), 4-tert-butylstyrene (Tg=127° C.), 2,4-dimethylstyrene (Tg=112° C.), 2,5-dimethylstyrene (Tg=143° C.), 3,5-dimethylstyrene (Tg=104° C.), isobornyl acrylate (Tg=94° C.), isobornyl methacrylate (Tg=110° C.), 4-methoxystyrene (Tg=113° C.), methylstyrene (Tg=20° C.), 4-methylstyrene (Tg=97° C.), 3-methylstyrene (Tg=97° C.), 2,4,6-trimethylstyrene (Tg=162° C.), and combinations thereof.

In some embodiments, soft phase can include a soft ethylenically-unsaturated monomer and a hard ethylenically-unsaturated monomer that, when copolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less).

The styrene/acrylic latex or acrylic latex can be derived from at least 10% to at most 95% by weight of one or more soft ethylenically-unsaturated monomers, based on the total weight of the monomers used to form the styrene/acrylic latex or acrylic latex (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, at least 85% by weight, or at least 90% by weight). The styrene/acrylic latex or acrylic latex can be derived from at most 95% by weight of one or more soft ethylenically-unsaturated monomers, based on the total weight of the monomers used to form the styrene/acrylic latex or acrylic latex (e.g., at most 90% by weight, at most 80% by weight at most 80% by weight, at most 75% by weight, at most 70% by weight, at most 65% by weight, at most 60% by weight, at most 55% by weight, at most 50% by weight, at most 45% by weight, at most 40% by weight, at most 35% by weight, at most 30% by weight, at most 25% by weight, at most 20% by weight, or at most 15% by weight).

The styrene/acrylic latex or acrylic latex can be derived from an amount of one or more soft ethylenically-unsaturated monomers ranging from any of the minimum percentages described above to any of the maximum percentages described above. For example, the styrene/acrylic latex or acrylic latex can be derived from 15% to 95% by weight of one or more soft ethylenically-unsaturated monomers, based on the total weight of the monomers used to form the styrene/acrylic latex or acrylic latex (e.g., from 15% to 85% by weight, from 25% to 80% by weight, from 30% to 70% by weight, or from 35% to 55% by weight). Preferably, the styrene/acrylic latex or acrylic latex can be derived from about 40% to about 95% by weight of one or more soft ethylenically-unsaturated monomers, based on the total weight of the monomers used to form the styrene/acrylic latex or acrylic latex.

Optionally, the styrene/acrylic latex or acrylic latex may contain a hard phase. The hard phase of the styrene/acrylic latex or acrylic latex may have a glass transition temperature (Tg), as calculated by the Flory-Fox equation, higher than the Tg of the soft phase. The Tg of the hard phase of the styrene/acrylic latex or acrylic latex may be 20° C. higher than that of the soft phase, for example.

The hard phase can include one or more hard ethylenically-unsaturated monomers. As used herein, the term “hard ethylenically-unsaturated monomer” refers to an ethylenically-unsaturated monomer that, when homopolymerized, forms a polymer having a Tg, as measured using DSC, of greater than 20° C. Hard ethylenically-unsaturated monomers are known in the art, and include, for example, methyl methacrylate (Tg=105° C.), ethyl methacrylate (Tg=65° C.), n-butyl methacrylate (Tg=20° C.), tert-butyl methacrylate (Tg=118° C.), tert-butyl acrylate (Tg=45° C.), isobutyl methacrylate (Tg=53° C.), vinyl acetate (Tg=30° C.), hydroxyethyl acrylate (Tg=15° C.), hydroxyethyl methacrylate (Tg=57° C.), cyclohexyl acrylate (Tg=19° C.), cyclohexyl methacrylate (Tg=92° C.), 2-ethoxyethyl methacrylate (Tg=16° C.), 2-phenoxyethyl methacrylate (Tg=54° C.), benzyl acrylate (Tg=6° C.), benzyl methacrylate (Tg=54° C.), hydroxypropyl methacrylate (Tg=76° C.), styrene (Tg=100° C.), 4-acetostyrene (Tg=116° C.), acrylamide (Tg=165° C.), acrylonitrile (Tg=125° C.), 4-bromostyrene (Tg=118° C.), n-tert-butylacrylamide (Tg=128° C.), 4-tert-butylstyrene (Tg=127° C.), 2,4-dimethylstyrene (Tg=112° C.), 2,5-dimethylstyrene (Tg=143° C.), 3,5-dimethylstyrene (Tg=104° C.), isobornyl acrylate (Tg=94° C.), isobornyl methacrylate (Tg=110° C.), 4-methoxystyrene (Tg=113° C.), methylstyrene (Tg=20° C.), 4-methylstyrene (Tg=97° C.), 3-methylstyrene (Tg=97° C.), 2,4,6-trimethylstyrene (Tg=162° C.), and combinations thereof.

In some embodiments, hard phase can include a soft ethylenically-unsaturated monomer that, when homopolymerized, forms a polymer having a glass transition temperature, as measured using DSC, of 20° C. or less (e.g., 20° C. or less, 10° C. or less, 0° C. or less, −10° C. or less, −20° C. or less, −30° C. or less, −40° C. or less, −50° C. or less, −60° C. or less, −70° C. or less, or −80° C. or less).

In some embodiments, hard phase can include a soft ethylenically-unsaturated monomer and a hard ethylenically-unsaturated monomer that, when copolymerized, forms a polymer having a glass transition temperature higher than the Tg of the soft phase. The Tg of the hard phase of the styrene/acrylic latex or acrylic latex may be 20° C. higher than that of the soft phase, for example.

In some embodiments, the styrene/acrylic latex or acrylic latex can be derived from greater than 5% by weight of one or more hard ethylenically-unsaturated monomers (e.g., 10% by weight or greater, 20% by weight or greater, 30% by weight or greater, 40% by weight or greater, 50% by weight or greater, 55% by weight or greater of the hard ethylenically-unsaturated monomer) based on the total weight of monomers used to form the styrene/acrylic latex or acrylic latex.

In some embodiments, the styrene/acrylic latex or acrylic latex can be derived from less than 60% by weight of one or more hard ethylenically-unsaturated monomers (e.g., 55% or less by weight, 50% or less by weight, 45% or less by weight, 40% or less by weight, 35% or less by weight, 30% or less by weight, 25% or less by weight, 20% or less by weight, 15% or less by weight, 10% or less by weight) based on the total weight of monomers used to form the styrene/acrylic latex or acrylic latex.

The styrene/acrylic latex or acrylic latex can be derived from one or more additional ethylenically-unsaturated monomers (e.g., (meth)acrylate monomers, vinyl aromatic monomers, etc.) as described below in addition to one or more soft ethylenically-unsaturated monomers, one or more phosphorus-containing monomers, and one or more acetoacetoxy monomers, keto or aldehyde monomers.

The styrene/acrylic latex or acrylic latex can be derived from greater than 0% by weight to 55% by weight of one or more additional ethylenically-unsaturated monomers. Additional ethylenically unsaturated monomers include (meth)acrylate monomers. These meth(acrylate) monomers include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C1-C20, C1-C12, C1-C8, or C1-C4 alkanols). Exemplary acrylate and methacrylate monomers include, but are not limited to, methyl (meth)acrylate, ethyl (meth)acrylate, n-butyl (meth)acrylate, iso-butyl (meth)acrylate, t-butyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri(meth)acrylate, pentaerythritol tetra(meth)acrylate and combinations thereof. In some embodiments, the acrylate component of the styrene/acrylic latex or acrylic latex comprises one or more (meth)acrylate monomers selected from the group consisting of methyl methacrylate, n-butyl acrylate, 2-ethylhexylacrylate, and combinations thereof. In some embodiments, the acrylate component of the styrene/acrylic latex or acrylic latex comprises methyl methacrylate and n-butyl acrylate.

In the styrene/acrylic latex or acrylic latex, additional ethylenically unsaturated monomers may include a vinyl aromatic having up to 20 carbon atoms, a vinyl ester of a carboxylic acid comprising up to 20 carbon atoms, a (meth)acrylonitrile, a vinyl halide, a vinyl ether of an alcohol comprising 1 to 10 carbon atoms, an aliphatic hydrocarbon having 2 to 8 carbon atoms and one or two double bonds, a alkoxy silane-containing monomer, a (meth)acrylamide, adhesion promoting ureido functional (meth)acrylate monomer, a (meth)acrylamide derivative, a sulfur-based monomer, or a combination of these monomers.

Suitable vinyl aromatic compounds include styrene, α- and p-methylstyrene, α-butylstyrene, 4-n-butylstyrene, 4-n-decylstyrene, vinyltoluene, and combinations thereof. Vinyl esters of carboxylic acids with alkanols having up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Alkoxy silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylalkoxysilanes, such as (meth)acryloyloxypropyltrimethoxysilane, γ-(meth)acryloxypropyltrimethoxysilane, and γ-(meth)acryloxypropyltriethoxysilane. Sulfur-containing monomers include, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. When present, the sulfur-containing monomers are generally present in an amount greater than 0% by weight to 5% by weight.

The styrene/acrylic latex or acrylic latex may include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

The styrene/acrylic latex or acrylic latex can be derived from one or more phosphorous acid-containing monomers based on the total weight of monomers. Ammonium, alkali metal ion, alkaline earth metal ion and other metal ion salts of these acids can also be used. Suitable phosphorus-containing monomers are vinylphosphonic acid and allylphosphonic acid, for example. Also suitable are the monoesters and diesters of phosphonic acid and phosphoric acid with hydroxyalkyl(meth)acrylates, especially the monoesters. Additionally suitable monomers are diesters of phosphonic acid and phosphoric acid that have been esterified once with hydroxyalkyl(meth)acrylate and also once with a different alcohol, such as an alkanol, for example. Suitable hydroxyalkyl(meth)acrylates for these esters are those specified below as separate monomers, more particularly 2-hydroxyethyl(meth)acrylate, 3-hydroxypropyl(meth)acrylate, 4-hydroxybutyl(meth)acrylate, etc. Corresponding dihydrogen phosphate ester monomers comprise phosphoalkyl(meth)acrylates, such as 2-phosphoethyl(meth)acrylate, 2-phosphopropyl(meth)acrylate, 3-phosphopropyl(meth)acrylate, phosphobutyl(meth)acrylate, and 3-phospho-2-hydroxypropyl(meth)acrylate. Also suitable are the esters of phosphonic acid and phosphoric acid with alkoxylated hydroxyalkyl(meth)acrylates, examples being the ethylene oxide or propylene oxide condensates of (meth)acrylates, such as H₂C═C(CH₃)COO(CH₂CH₂O)ₙP(OH)₂ and H₂C═C(CH₃)COO(CH₂CH₂O)ₙP(═O)(OH)₂, in which n is 1 to 50. Of further suitability are phosphoalkyl crotonates, phosphoalkyl maleates, phosphoalkyl fumarates, phosphodialkyl(meth)acrylates, phosphodialkyl crotonates and allyl phosphates.

Examples of phosphate containing unsaturated monomers are Sipomer® PAM 4000, distributed by Solvay (is a colorless to pale yellow clear, ethyl methacrylate phosphate and phosphate alkyl methacrylate with a slight odor of acrylic, CAS no. 52628 03-02) or Sipomer® PAM 200, distributed, by, for example, Solvay (is a phosphate ester of PPG monomethacrylate). Alkali or alkaline earth metal ion or ammonia neutralized salts of the above acids and combinations thereof can also be used. In some instances, the monomer mixture can include a mixture of ethylenically unsaturated acids, for instance (meth)acrylic acid and phosphorous acid containing monomers, or itaconic acid and phosphorous acid containing monomers or combination of carboxylic and phosphorous acid containing monomers. Alkali or alkaline earth metal ion or ammonia neutralized salts of the above acids and combinations thereof can also be used.

The styrene/acrylic latex or acrylic latex can be derived from greater than 0% by weight of one or more phosphorus—containing monomers, based on the total weight of the monomers used to form the styrene/acrylic latex or acrylic latex (e.g., at least 0.25% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight or at least 5% by weight or at least 10% by weight). The styrene/acrylic latex or acrylic latex can be derived from 10% or less by weight of one or more phosphorus-containing monomers, based on the total weight of the monomers used to form the styrene/acrylic latex or acrylic latex (e.g., from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight, or from 0.25% or less by weight).

The styrene/acrylic latex or acrylic latex can be derived from greater than 0% by weight of one or more acid-containing monomers, based on the total weight of the monomers used to form the styrene/acrylic latex or acrylic latex (e.g., at least 0.5% by weight, at least 1% by weight, at least 2% by weight, at least 3% by weight, at least 4% by weight, at least 5% by weight, at least 6% by weight, at least 7% by weight, at least 8% by weight, at least 9% by weight at least 10% by weight, at least 15% by weight, at least 20% by weight, at least 25% by weight, at least 30% by weight). The styrene/acrylic latex or acrylic latex can be derived from 30% or less by weight of one or more acid-containing monomers, based on the total weight of the monomers used to form the second copolymer (e.g., from 25% or less by weight, from 20% or less by weight, from 15% or less by weight, from 10% or less by weight, from 5% or less by weight, from 3% or less by weight, or from 1% or less by weight). Preferably, the styrene/acrylic latex or acrylic latex can be derived from about 0.5% to about 10% by weight of one or more acid-containing monomers, based on the total weight of the monomers used to form styrene/acrylic latex or acrylic latex.

The styrene/acrylic latex or acrylic latex can be derived from one or more carboxylic acid-containing monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

The styrene/acrylic latex or acrylic latex can be derived from an amount of one or more acid-containing monomers ranging from any of the minimum percentages described above to any of the maximum percentages described above. For example, the styrene/acrylic latex or acrylic latex can be derived from greater than 0.5% by weight to 30% by weight of one or more acid-containing monomers, based on the total weight of the monomers used to form the styrene/acrylic latex or acrylic latex (e.g., from greater than 2% by weight to 20% by weight of one or more acid-containing monomers). In certain embodiments, the styrene/acrylic latex or acrylic latex is derived from greater than 2% by weight to 30% by weight (e.g., greater than 2% by weight to 10% by weight, greater than 2% by weight to 15% by weight, or greater than 2% by weight to 20% by weight) acid monomers.

The styrene/acrylic latex or acrylic latex can be derived from one or more sulfur acid-containing monomers. Suitable sulfur acid monomers are vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, 2-acrylamido-2-methylpropanesulfonic acid and their ionic salts with ammonium and metal ions. Suitable styrenesulfonic acids and derivatives thereof are styrene-4-sulfonic acid and styrene-3-sulfonic acid, and their ionic salt with metal ions, such as sodium styrene-3-sulfonate and sodium styrene-4-sulfonate.

The styrene/acrylic latex or acrylic latex can be derived from an amount of one or more phosphorus-containing monomers ranging from any of the minimum percentages described above to any of the maximum percentages described above. For example, the styrene/acrylic latex or acrylic latex can be derived from greater than 0% by weight to 10% by weight of one or more phosphorus-containing monomers, based on the total weight of the monomers used to form the styrene/acrylic latex or acrylic latex (e.g., from greater than 0% by weight to 5% by weight of one or more phosphorus-containing monomers or from greater than 0% by weight to 2.5% by weight of one or more phosphorus-containing monomers). In certain embodiments, the styrene/acrylic latex or acrylic latex is derived from greater than 0% by weight to 10% by weight (e.g., greater than 0% by weight to 5% by weight, greater than 0% by weight to 3% by weight, greater than 0% by weight to 2.5% by weight, or greater than 0% by weight to 1.5% by weight) 2-phosphoethyl methacrylate (PEM).

The styrene/acrylic latex or acrylic latex may further comprise one or more cross-linkable monomers, such as acrylamide monomers, methacrylate monomers, acetoacetoxy monomers, ketone monomers, aldehyde monomers, silane monomers, and combinations thereof. Suitable acetoacetoxy monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Suitable keto monomers include diacetone acrylamide (DAAM). Keto monomers include keto-containing amide functional monomers defined by the general structure below

CH₂═CR¹C(O)NR²C(O)R³

wherein R¹ is hydrogen or methyl; R² is hydrogen, a C₁-C₄ alkyl group, or a phenyl group; and R³ is hydrogen, a C₁-C₄ alkyl group, or a phenyl group. For example, the (meth)acrylamide derivative can be diacetone acrylamide (DAAM) or diacetone methacrylamide. Suitable aldehyde monomers include (meth)acrolein.

The styrene/acrylic latex or acrylic latex can be derived from greater than 0% by weight of one or more acetoacetoxy, keto or aldehyde monomers, based on the total weight of the monomers used to form the styrene/acrylic latex or acrylic latex (e.g., at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, at least 9.5% by weight, at least 10% by weight or at least 15% by weight). The styrene/acrylic latex or acrylic latex can be derived from 15% or less by weight of one or more acetoacetoxy, keto or aldehyde monomers, based on the total weight of the monomers used to form the styrene/acrylic latex or acrylic latex (e.g., from 10% or less by weight, from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

Acetoacetoxy, keto or aldehyde groups can be reacted with polyamines to form crosslinks. Polyamines with primary amine groups are preferred. Examples of suitable polyfunctional amines include polyetheramines, polyalkyleneamines, polyhydrazides, or a combination thereof. Specific examples of polyfunctional amines include polyfunctional amines sold under the trade names, Baxxodur, Jeffamine, and Dytek. In some embodiments amines are difunctional or higher functional. Polyfunctional amine-terminated polyoxyalkylene polyols (e.g., Jeffamines or Baxxodur amines), examples being polyetheramine T403, polyetheramine D230, polyetheramine D400, polyetheramine D2000, or polyetheramine T5000). In some embodiments, amines include Dytek A, Dytek EP, Dytek HMD, Dytek BHMT, and Dytek DCH-99. In some embodiments, amines are polyhydrazides derived from alipahtic and aromatic polycarboxylic acids including adipic dihydrazide, succinic dihydrazide, citric trihydrazide, isophthalic dihydrazide, phthalic dihydrazide, or trimellitic trihydrazide. Other amines include diethylenetriamine, triethylenetetramine, tetraethylenepentamine, pentaethylenehexamine, hexaethyleneheptamine, heptaethyleneoctamine, 5 octaethylenenonamine, higher polyimines e.g., polyethyleneimines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N,N-bis(3-aminopropyl)ethylenediamine, N′,N-bis(3-aminopropyl)ethylenediamine, N,N-bis(3-aminopropyl)propane-1,3-diamine, N,N-bis(3-10 aminopropyl)butane-1,4-diamine, N,N′-bis(3-aminopropyl)propane-1,3-diamine, N,N′-bis(3-aminopropyl)butane-1,4-diamine, N,N,N′N′-tetra(3-aminopropyl)ethylenediamine, N,N,N′N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine. The preferred amines are polyhydrazides or adipic acid dihydrazide when diacetone acrylamide and its derivative monomer are used.

The acetoacetoxy, keto or aldehyde group to primary amine group ratio varies between 10:1 equivalents to 1:1.2 equivalents (e.g., 9:1 equivalents to 1:1.1 equivalents, 8:1 equivalents to 1:1 equivalents, 7:1 equivalents to 1:1 equivalents, 6:1 equivalents to 1:1 equivalents, 5:1 equivalents to 1:1 equivalents).

The styrene/acrylic latex or acrylic latex can be derived from an amount of one or more acetoacetoxy, keto or aldehyde monomers ranging from any of the minimum percentages described above to any of the maximum percentages described above. For example, the styrene/acrylic latex or acrylic latex can be derived from greater than 0% by weight to 10% by weight of one or more acetoacetoxy, keto or aldehyde monomers, based on the total weight of the monomers used to form the styrene/acrylic latex or acrylic latex (e.g., from 0.25% by weight to 10% by weight of one or more acetoacetoxy, keto or aldehyde monomers, from 0.5% by weight to 5% by weight of one or more acetoacetoxy, keto or aldehyde monomers, from 1% by weight to 7.5% by weight of one or more acetoacetoxy, keto or aldehyde monomers, from 2.5% by weight to 7.5% by weight of one or more acetoacetoxy, keto or aldehyde monomers, or from 5% by weight to 7.5% by weight of one or more acetoacetoxy, keto or aldehyde monomers). In certain embodiments, the styrene/acrylic latex or acrylic latex is derived from greater than 0% by weight to 10% by weight (e.g., from 1% by weight to 7.5% by weight, from 2.5% by weight to 7.5% by weight, or from 5% by weight to 7.5% by weight) acetoacetoxyethyl (meth)acrylate (AAEM). In certain embodiments, the styrene/acrylic latex or acrylic latex is derived from greater than 0% by weight to 10% by weight (e.g., from 0.25% by weight to 10% by weight, from 0.5% by weight to 5% by weight, from 1% by weight to 7.5% by weight, from 2.5% by weight to 7.5% by weight, or from 5% by weight to 7.5% by weight) of diacetone acrylamide (DAAM).

The molecular weight of the styrene/acrylic latex or acrylic latex may be described by its number average molecular weight (M_{w}). Weight average molecular weight may be determined using static light scattering, for example, and may be calculated as shown below, wherein Nᵢ is the number of molecules of molecular mass Mᵢ:

M_{w}=ΣᵢNᵢMᵢ²/ΣᵢNᵢMᵢ

The styrene/acrylic latex or acrylic latex described herein have a weight average molecular weight Mw of 20,000 Daltons or greater (e.g., 20,000 Daltons or greater, 30,000 Daltons or greater, 40,000 Daltons or greater, 50,000 Daltons or greater, 60,000 Daltons or greater, or 70,000 Daltons or greater, 80,000 Daltons or greater, 90,000 Daltons or greater, or 100,000 Daltons or greater).

The styrene/acrylic latex or acrylic latex described herein may have a gel content from about 0% to about 100%. The gel content of the styrene/acrylic latex or acrylic latex may be measured by dissolving the dry polymer in tetrahydrofuran (THF) and measuring the insoluble content. The ratio of the insoluble content to the total dry polymer may then be determined.

The styrene/acrylic latex or acrylic latex may have a gel content greater than 50% (e.g., 50% or greater, 60% or greater, 70% or greater, 80% or greater, 90% or greater, or 100%).

In some embodiments, the adhesive A, water-borne latex emulsion, and one or more additives are combined to form the pressure-sensitive adhesive layer A. Exemplary additives include, but are not limited to, thickeners, wetting aids, defoamers, tackifiers, crosslinkers (e.g., metal salts, silane coupling agents such as glycidoxyalkyl alkoxylsilanes, or multifunctional acrylates such as trimethylolpropane triacrylate (TMPTA) or hexanediol diacrylate (HDDA)), fillers (e.g., calcium carbonate, fibers, carbon black, zinc oxide, titanium dioxide, chalk, solid or hollow glass beads, microbeads of other materials, silica, silicates), low-temperature plasticizers, nucleators, expandants, flow additives, fluorescent additives, polyolefins, rheology modifiers, surfactants, leveling additives, compounding agents and/or aging inhibitors in the form of primary and secondary antioxidants or in the form of light stabilizers, photoinitiators, pigments, dyes, or mixtures thereof. The coating can be applied to a surface and dried to produce a pressure-sensitive adhesive coating. The pressure sensitive adhesives disclosed herein can be produce strippable (temporary) or permanent adhesive bonds.

Exemplary tackifiers (tackifying resins) include, but are not limited to, natural resins, such as rosins and their derivatives formed by disproportionation or isomerization, polymerization, dimerization and/or hydrogenation. Tackifiers can include rosin and rosin derivatives (rosin esters, including rosin derivatives stabilized by, for example, disproportionation or hydrogenation) polyterpene resins, terpene-phenolic resins, alkylphenol resins, and aliphatic, aromatic and aliphatic-aromatic hydrocarbon resins, and combinations thereof. In some embodiments, the tackifying resins can be present in salt form (with, for example, monovalent or polyvalent counterions (cations)) or in esterified form. Alcohols used for the esterification can be monohydric or polyhydric. Exemplary alcohols include, but are not limited to, methanol, ethanediol, diethylene glycol, triethylene glycol, 1,2,3-propanethiol, and pentaerythritol.

Exemplary hydrocarbon tackifying resins include, but are not limited to, coumarone-indene resins, polyterpene resins, and hydrocarbon resins based on saturated CH compounds such as butadiene, pentene, methylbutene, isoprene, piperylene, divinylmethane, pentadiene, cyclopentene, cyclopentadiene, cyclohexadiene, styrene, α-methylstyrene, and vinyltoluene.

In some embodiments, the tackifying resins are derived from natural rosins. In some embodiments, the tackifying resin is selected from any resin that does not interfere with UV-curing (for instance, a resin that does not absorb so much UV radiation that it would prevent the PSA from curing satisfactorily). In some embodiments, the tackifying resins are chemically modified rosins. In some embodiments, the tackifying resins are fully hydrogenated. In some embodiments, the rosins comprise abietic acid or abietic acid derivatives. Exemplary commercially available tackifiers include, but are not limited to, FORAL® AX-E, (fully Hydrogenated Rosin is a thermoplastic, acidic resin produced by hydrogenating rosin to an exceptionally high degree), FORAL® 85 (Hydrogenated Rosinate is a cosmetic grade resin derived from the esterification of a highly stabilized gum rosin and glycerol), and REGALRITE® 9100 (hydrocarbon resin which is a partially hydrogenated water-white inert thermoplastic resin derived from petrochemical feedstocks) by Eastman Chemical Company.

Exemplary crosslinkers include, but are not limited to, metal chelates, polyfunctional isocyanates, polyfunctional amines, polyfunctional alcohols, polyfunctional acrylates, and silane coupling agents such as glycidoxyalkyl alkoxylsilanes. A commercially available includes, but is not limited to, LAROMER® TMPTA (trimethylol propane triacrylate) by BASF.

In one or more embodiments, the pressure-sensitive adhesive layer A may have a thickness of 25 μm to 250 μm, or from 25 μm to 100 μm.

Useful adhesive compositions are commercially available. For example, copolymers useful for the formulation of adhesive A include those available under the tradename Kurarity™ (Ti-block and di-block acrylic-based polymers) and by Kuraray. Kraton™, Vector™, Septon™ (is a series of high-performance thermoplastic rubbers using isoprene technology. It consists of a series of hydrogenated styrenic block copolymers that exhibit rubber-like properties over a wide range of temperatures and hardnesses) and by Kuraray.

Hot-Melt Adhesive B

According to various embodiments described herein, the curable hot-melt adhesive that may be used for forming the pressure-sensitive adhesive layer B may be a UV-curable acrylic-based hot-melt adhesive or a UV curable styrenic block copolymer based hot-melt adhesive. For example, U.S. Pat. No. 9,334,423, which is incorporated by reference herein in its entirety, especially for the teaching of compositions and methods comprising an acrylic block copolymer and a UV-curable copolymer, wherein the composition is capable of being crosslinked by means of ultraviolet radiation useful for instance, in pressure-sensitive adhesive applications.

Suitable UV-curable acrylic-based or styrenic-based hot-melt adhesive comprise an acrylic block copolymer and/or styrenic block copolymer, a UV-curable copolymer, and a photoinitiator, wherein the composition is capable of being crosslinked by means of ultraviolet radiation.

The monomer for forming the acrylic and/or styrenic block copolymer can include, for instance, one or more monomers selected from a methyl methacrylate, a vinyl aromatic (e.g. styrene), cyclohexyl methacrylate, isobornyl methacrylate, acrylonitrile, or mixtures thereof, to produce a polymer block having a measured glass transition temperature of 50-200° C. Exemplary vinyl aromatics include, but are not limited to, styrene, α-methylstyrene, and p-methylstyrene, vinyl toluene, and mixtures thereof.

The UV-curable copolymer can be derived from a (meth)acrylate monomer, the UV-curable copolymer being capable of being crosslinked by means of ultraviolet radiation. In some embodiments, the (meth)acrylate monomer is selected from the group consisting of butyl acrylate, 2-ethylhexyl acrylate, and mixtures thereof. The photoinitiator can include acrylated benzophenone. Optionally, the UV-curable copolymer may contain functional groups that are receptive to reaction-initiated free radical or cationic photoinitiators triggered by UV radiation.

In some embodiments, the photoinitiator is bonded to a monomer unit of the UV-curable copolymer. For example, the UV-curable copolymer can include a (meth)acrylate monomer unit that has a pendant benzophenone group bonded to it. In some embodiments, in addition to or in place of the photoinitiator bonded to the UV-curable copolymer, the composition can include a photoinitiator that is not bonded to the UV-curable copolymer but that is provided separately in the composition (e.g., by post-adding the photoinitiator to the composition).

In one or more embodiments, the adhesive is at least partially cured after being applied to the membrane, as will be discussed in greater detail below. In one or more embodiments, the adhesive is cured to an extent that it is not thermally processable in the form it was prior to cure. In these or other embodiments, the cured adhesive is characterized by a cross-linked infinite polymer network. While at least partially cured, the adhesive layer of one or more embodiments is essentially free of curative residue such as sulfur or sulfur crosslinks and/or phenolic compounds or phenolic-residue crosslinks.

In one or more embodiments, the pressure-sensitive adhesive layer B may have a thickness of from 50 μm to 250 μm, or from 50 μm to 100 μm.

In one or more embodiments, a total thickness of the layers containing at least the pressure-sensitive adhesive layer A and the pressure-sensitive adhesive layer B is not more than 650 μm, or not more than 600 μm, or not more than 550 μm, or not more than 500 μm.

Release Liner

According to various embodiments described herein, the release liner may be a polymeric film or extrudate based on polypropylene, polyester, high-density polyethylene, medium-density polyethylene, low-density polyethylene, polystyrene or high-impact polystyrene, or a cellulosic substrate. It is known in the art that a coating or layer may be applied to the film and/or cellulosic substrate, and that it may include a silicon-containing or fluorine-containing coating. These coatings include, for example, silicone oil, polysiloxane or hydrocarbon waxes.

According to various embodiments described herein, the release liner may have a thickness of from 50 μm to 500 μm.

Preparation of Multilayer Composite

The polymeric membranes used in the multilayer composites of the present invention may be prepared by conventional techniques and commercially available. For example, EPDM membranes useful in the instant multilayer composite include those available from companies such as Carlisle, John Manville or Firestone, and which are offered under a variety of tradenames.

According to various embodiments described herein, the curable adhesives can be combined by simultaneous or sequential extrusion onto the polymeric membrane by using known methods. The adhesive can then subsequently be cured by using, for example, UV radiation. The release film can be applied to the adhesive layer, and the membrane can then be subsequently rolled for storage and/or shipment. The multilayer composites according to embodiments of the present invention may be prepared by a single continuous process.

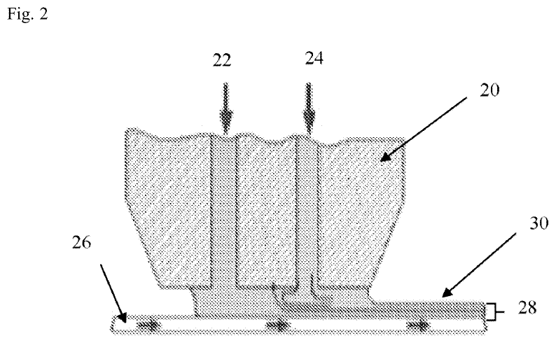

FIG. 2 shows a dual slot die 20 coextruding adhesive A 22, which is heated to a sufficient temperature to allow the adhesive to be applied onto a polymeric membrane 26, and hot-melt adhesive B 24, which is heated to a sufficient temperature to allow the adhesive to be applied onto a polymeric membrane 26, to form an adhesive coating layer 28. The adhesive coating layer 28 is subjected to a UV-curing step 30 where sufficient UV energy is applied to the coating layer to effect a desirable curing or crosslinking of the UV curable adhesive. In is generally known in the art, and not shown here, that once the adhesive has been sufficiently cured by exposure to UV curing step, the composite may be passed over one or more chill rolls, and a release liner can be applied to the cured coating. Following application of the release liner, the composite is wound. The multilayer composite is ready to be laminated onto roofing construction site after removing the release liner.

According to various embodiments described herein, adhesive A is heated to a temperature of from about 120 to about 160° C., in other embodiments from about 125 to about 155° C., and in other embodiments from about 130 to about 150° C.

Adhesive A has more cold flow compared to hot-melt adhesive B, allowing it to relieve stress during expansion or contraction of the membrane during service. The cold flow properties of hot-melt adhesive may be quantified, for example, by determining the elastic modulus of the hot melt adhesive. The elastic modulus maybe determined using methods known to a person of skill in the art. In some embodiments, the elastic modulus of adhesive A is less than the elastic modulus of adhesive B, in other embodiments the elastic moduli of A and B differ by 20%, and in yet other embodiments the elastic moduli differ by 50%.

According to various embodiments described herein, hot-melt adhesive B is heated to a temperature of from about 120 to about 160° C., in other embodiments from about 125 to about 155° C., and in other embodiments from about 130 to about 150° C.

According to various embodiments described herein, the pressure-sensitive adhesive layer A may have a thickness of 25 μm to 250 μm, or from 25 μm to 100 μm.

According to various embodiments described herein, the pressure-sensitive adhesive layer B may have a thickness of 25 μm to 250 μm, or from 25 μm to 100 μm.

In one or more embodiments, once layer A and layer B are combined, they may be subjected to a UV curing step. The UV curing step subjects the adhesive coating to a UV dosage of from about 40 to about 80 millijoule/cm2. It was advantageously observed that the instant UV dosage preserves good peel while the lower thickness allows good thru cure and preserving good shear. It is well known that subjecting the adhesive coating to high doses of UV radiation results in non-uniformities and has a deleterious impact on the coating.

Characteristics of the Multilayer Composite

According to various embodiments described herein, the layer of crosslinked pressure-sensitive adhesive B disposed on a surface of the membrane according to the present invention may be characterized by an advantageous peel strength of at least 4 pounds, or at least 5 pounds, or at least 6 pounds, or at least 7 pounds or at least 8 pounds.

In one or more embodiments, the layer of crosslinked pressure-sensitive adhesive disposed on a surface of the membrane according to the present invention may be characterized by an advantageous dead load shear minimum of 15 hours, or least 16 hours, or at least 17 hours, or at least 18 hours, or least 19 hours, or least 20 hours, or least 21 hours or least 22 hours or least 23 hours or least 24 hours or least 25 hours; at 1 kg with a size of 1 inch by 1 inch.

Application to a Roof Surface

The multilayer composites of the present invention can advantageously be applied to a roof surface (also known as roof substrate) by using standard peel and stick techniques. These techniques are generally known to a person of skill in the art. For example, the multilayer composites can be unrolled on a roof surface and placed into position. The multilayer composites can then subsequently be adhered to the roof surface by using various techniques including the use of rollers and the like to mate the adhesive to the substrate.

It has advantageously been discovered that the pressure-sensitive adhesive layers employed in the membranes of the present invention allow the multilayer composites to be adhered to a variety of roofing surfaces. These include, but are not limited to, wood decks, concrete decks, steel decks, faced construction boards, and existing membrane surfaces. In particular embodiments, the membranes of the present invention are adhered, through the cured adhesive layer disclosed herein, to a faced construction board such as, but not limited to, polyisocyanurate insulation boards or cover boards that include facers prepared from polar materials. For example, the adhesives of the present invention provide advantageous adhesion to facers that contain cellulosic materials and/or glass materials. It is believed that the polar nature of the adhesive is highly compatible with the polar nature of these facer materials and/or any adhesives or coatings that may be carried by glass or paper facers. Accordingly, embodiments of the present invention are directed toward a roof deck including a construction board having a cellulosic or glass facer and a membrane secured to the construction board through an at least partially cured polyacrylate adhesive layer in contact with a glass or cellulosic facer of the construction board.

It has advantageously been discovered that the pressure-sensitive adhesive layers employed in the multilayer composites of the present invention allow the multilayer composites to be applied to the roofing surfaces in any temperature window, and at any time installation without exhibiting channeling and tunneling.

### EXAMPLES

This example demonstrates the advantages and performance characteristics of the present invention.

### Example

### Example 1: Multilayer Composites

Five multilayer composites were formulated using the starting materials and conditions shown below in Table 1. The LSE component of Formulations 1 and 2 comprises two different UV-curable acrylates and a rosin ester as a tackifier. The thermal cure (TC) component of formulation 2 is a combination of acResin andjoncryl 4285 crosslinker (97./2.5). In this Example, the water-based acrylic was modified with Lumiten 0.5% ISC and thickened to roughly 15,000 cP viscosity prior to being mixed under vacuum. The coatings were either added directly or transferred to ethylene propylene diene (EPDM) substrate.

TABLE 1

| Sample ID | | | | |
|---|---|---|---|---|
| 1 | 2 | 3 | 4 | 5 |
| Description | | | | |
| Water-based | TC/LSE | Acrylate | Acrylate | Acrylate |
| Acrylic/LSE | Dual | UV-curable | UV-curable | UV-curable |
| Dual Layer | Layer | Control | Control | Control |

Layer A

| | | | | | |
|---|---|---|---|---|---|
| Water-based Acrylic | 100% | — | — | — | — |
| UV-curable acrylate | — | 97.5% | 100% | 100% | 100% |
| Joncryl ADR 4385 | — | 2.5% | — | — | — |
| Dry film thickness (mil) | 6 | 6 | 10 | 10 | 7 |
| UV Dose (mJ/cm²) | — | — | 125 | 2 × 125 | 125 |
| Oven Cure | — | 9 min (RT | — | — | — |
| | | to 140° C.) | | | |
| Direct/transfer coating | Direct to | Direct (cured | Direct (cured | Direct (cured | Direct (cured |
| | EPDM | on EPDM) | on EPDM) | on EPDM) | on EPDM) |

Layer B

| | | | | | |
|---|---|---|---|---|---|
| LSE | 100% | 100% | — | — | — |
| Dry film thickness (mil) | 4 | 4 | — | — | — |
| UV Dose (mJ/cm²) | 3 × 60 | 3 × 60 | — | — | — |
| Direct/transfer coating | Transfer | Transfer | — | — | — |
| Substrate | EPDM | EPDM | EPDM | EPDM | EPDM |
| Total film thickness (mil) | 10 | 10 | 10 | 10 | 7 |

### Example 2: Peel Strength and Shear Adhesion Testing

The five formulations described above were then secured to a stainless steel panel, and the test specimens were then tested for peel strength according to PSTC 101 (“SS Peel”). Each test was repeated three times. The results are shown in Table 2.

TABLE 2

| Sample ID | 1 | 2 | 3 | 4 | 5 |
|---|---|---|---|---|---|
| SS Peel (lbf) | 11.00715 | 6.74906 | 6.67436 | 9.2647 | 6.75042 |
| 30 min dwell | 10.36956 | 6.77191 | 7.10571 | 8.9871 | 7.28231 |
| | 6.32604 | 6.36615 | 7.45065 | 10.0945 | 6.69552 |
| Avg. | 9.23 | 6.63 | 7.07 | 9.45 | 6.91 |

Formulation 1 showed failure in both cohesion and adhesion to EPDM in roughly equal measure. Formulation 2 showed failure predominantly in cohesion, with some failure in adhesion to EPDM. Formulations 3 and 4 failed in cohesion. Formulation 5 demonstrated a different failure mode, referred to herein as “striping”. This failure mode leaves alternating solid stripes of adhesive on the substrate as force builds until the adhesion fails and the adhesive releases from the substrate, whereupon the cycle begins again. This results in the force steadily rising, followed by a sudden drop, followed by another steady rise and another sudden drop, etc.

The formulations were then subjected to shear adhesion failure testing (“SAFT”) according to TEST METHODS for Pressure Sensitive Adhesive Tapes, 16 th Edition, from Pressure Sensitive Tape Counsil (PSTC) 2014 test method PSTC-17. The results are shown below in Table 3.

TABLE 3

| Sample ID | 1 | 2 | 3 | 4 | 5 |
|---|---|---|---|---|---|
| SAFT (° F.) | 167.3 | 124 | 79.2 | 90.8 | 165.9 |
| 1″ × 1″ × 1 kg | 169.6 | 89.8 | 78.9 | 91.3 | 163.6 |
| | 166.4 | 75 | 77.8 | 93.8 | 112.4 |
| Avg. | 167.77 | 96.27 | 78.63 | 91.97 | 147.30 |
| SAFT (min) | 92.3 | 49 | 4.2 | 15.38 | 90.9 |
| | 94.6 | 14.8 | 3.9 | 16.3 | 88.6 |
| | 91.4 | 14.8 | 2.8 | 18.8 | 37.4 |

In each case, the predominant mode of failure was through cohesion failure.

As can be seen in the results in Tables 2 and 3, Formulation 1 performs either comparably or better than the remaining formulations.

Various modifications and alterations that do not depart from the scope and spirit of this invention will become apparent to those skilled in the art. This invention is not to be duly limited to the illustrative embodiments set forth herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The term “substantially all of” means an amount or area coverage of 80% or more and is merely intended to serve as a shorthand method of referring individually to each separate value falling within the range from 80% to 100%.

Preferred embodiments of this invention are described herein, including the best mode known to the inventors for carrying out the invention. It should be understood that the illustrated embodiments are exemplary only, and should not be taken as limiting the scope of the invention.

1.-29. (canceled)

30. A multilayer composite comprising:
a polymeric membrane;
a adhesive layer A;
a hot-melt adhesive layer B; and
a release liner,
wherein the adhesive layer A comprises an ultraviolet (UV) curable pressure-sensitive adhesive or a water-borne latex adhesive;
wherein the hot-melt adhesive layer B comprises a ultraviolet (UV) curable pressure-sensitive adhesive that is at least partially cured;
wherein the adhesive layer A has a thickness of from 25 to 250 μm, and
wherein the hot-melt adhesive layer B has a thickness of from 50 to 250 μm.

31. The multilayer composite of claim 30, wherein the adhesive layer A does not undergo UV cure prior to combination with layer B.

32. The multilayer composite of claim 30, wherein the adhesive layer A is in contact with substantially all of one planar surface of the polymeric membrane.

33. The multilayer composite of claim 30, wherein the hot-melt adhesive layer B is in contact with substantially all of one planar surface of the polymeric membrane.

34. The multilayer composite of claim 30, wherein the adhesive layer A comprises a UV-cured poly(acrylate) resin.

35. The multilayer composite of claim 30, wherein the water-borne latex adhesive comprises at least one styrene/acrylic latex, acrylic latex, styrene butadiene latex or nitrile butadiene latex derived from at least one monomer selected from the group consisting of styrene, 2-ethylhexyl acrylate, methyl acrylate, methyl methacrylate, ethyl acrylate, ethyl methacrylate, butyl acrylate, butyl methacrylate, acrylamide, acrylic acid, methacrylic acid, itaconic acid, and vinylphosphonic acid.

36. The multilayer composite of claim 30, wherein the hot-melt adhesive layer B is selected from the group consisting of UV curable acrylic PSA and UV curable styrenic block copolymer PSA.

37. The multilayer composite of claim 30, wherein the polymeric membrane is selected from the group consisting of thermoplastic membrane, ethylene-propylene-diene terpolymer rubber (EPDM), TPO, PVC, modified bitumen, rubber membrane, asphaltic membranes, and fibrous membranes.

38. The multilayer composite of claim 30, wherein the multilayer composite has a peel strength, when adhered to a stainless steel panel and tested according to PSTC 101, of at least 6 psi.

39. The multilayer composite of claim 30, where the multilayer composite has a dead load shear, when adhered to a stainless steel panel and tested according to PSTC 107, of at least 0.5 hour.

40. The multilayer composite of claim 30, wherein the adhesive layer A has a thickness of from 25 to 100 μm, and wherein the hot-melt adhesive layer B has a thickness of from 50 to 100 μm.

41. The multilayer composite of claim 40, wherein the adhesive layer A further comprises one or more additive.

42. The multilayer composite of claim 30, wherein the multilayer composite is a roofing membrane.

43. A roofing membrane comprising the multilayer composite of claim 30.

44. A process for forming a multilayer composite, the process comprising:
(a) heating a melt-extrudable, UV-curable pressure-sensitive layer A,
(b) heating a melt-extrudable, UV-curable pressure-sensitive adhesive B,
(c) extruding the layer A and the adhesive B to a planar surface of a polymeric membrane such that adhesive is in contact with substantially all of one planar surface of the polymeric membrane, forming an adhesive coating layer comprising an adhesive layer A and a hot-melt adhesive layer B;
wherein the adhesive layer A has a thickness of from 25 to 250 μm, and
wherein the hot-melt adhesive layer B has a thickness of from 50 to 250 μm,
(d) subjecting the adhesive coating layer to UV radiation;
(e) optionally, cooling the adhesive coating layer;
(f) applying a release liner to the adhesive coating layer to form a multilayer composite; and
(g) winding the composite.

45. The process of claim 44, wherein the melt-extrudable, UV-curable pressure-sensitive layer A further comprises a water-borne latex adhesive.

46. The process of claim 44, wherein in step (c) the adhesive A and the adhesive B are coextruded simultaneously.

47. The process of claim 44, wherein in step (c) the adhesive layer A and the adhesive B are extruded sequentially.

48. The process of claim 44, wherein the adhesive layer A comprises a UV-curable poly(acrylate) resin, and a water-borne latex adhesive.

49. The process of claim 44, the hot-melt adhesive layer B comprises a UV-cured poly(acrylate) resin.

50. The process of claim 44, wherein the hot-melt adhesive layer B is selected from the group consisting of UV curable acrylic PSA and UV curable styrenic block copolymer PSA.

51. The process of claim 44, wherein the polymeric membrane is selected from the group consisting of thermoplastic membrane, ethylene-propylene-diene terpolymer rubber (EPDM), TPO, PVC, modified bitumen, rubber membrane, asphaltic membranes, and fibrous membranes.

52. The process of claim 44, wherein the coextruding simultaneously the adhesive A and the adhesive B are coextruded simultaneously in a dual slot die configuration onto a moving web of thermoplastic membrane, ethylene-propylene-diene terpolymer rubber (EPDM), TPO, PVC, modified bitumen, rubber membrane, asphaltic membranes, and fibrous membranes

53. The process of claim 44, wherein the adhesive A and/or the adhesive B comprises an additive selected from the group consisting of a tackifier, a plasticizer, one or more photoinitiator.

54. The process of claim 44, wherein the adhesive A/B is heated to a temperature of from about 120 to about 160° C.

55. The process of claim 44, wherein subjecting the coating to UV radiation comprises subjecting the adhesive coating layer to a UV dosage of from about 40 to about 80 millijoules/cm2.

56. The process of claim 44, wherein the multilayer composite has a width of from about 1 to about 20 meters.

57. A method for roofing a structure comprising
(a) providing the multilayer composite of claim 30,
(b) removing the release liner from the multilayer composite forming linerless multilayer composite, and
(c) adhering/laminating/installing the linerless multilayer composite onto a roof substructure forming a roof laminate.

58. A multilayer composite comprising:
a substrate;
an adhesive layer A;
a hot-melt adhesive layer B; and
a release liner,
wherein the adhesive layer A comprises an ultraviolet (UV) curable pressure-sensitive adhesive and a water-borne latex adhesive;
wherein the hot-melt adhesive layer B comprises a ultraviolet (UV) curable pressure-sensitive adhesive that is at least partially cured;
wherein the adhesive layer A has a thickness of from 25 to 250 μm, and wherein the hot-melt adhesive layer B has a thickness of from 50 to 250 μm.
